(19) United States
(12) Patent Application Publication
(10) Pub. No.: US 2023/0087614 A1
(43) Pub. Date: Mar. 23, 2023

(54) RELIABLE MULTICAST TRANSMISSION WITH UPLINK FEEDBACK

(71) Applicant: MediaTek Singapore Pte. Ltd., Singapore (SG)

(72) Inventors: Xuelong Wang, San Jose, CA (US); Pradeep Jose, Cambridge (GB); Chia-Chun Hsu, Hsinchu City (TW)

(21) Appl. No.: 18/059,363

(22) Filed: Nov. 28, 2022

Related U.S. Application Data
(63) Continuation of application No. PCT/CN2021/103207, filed on Jun. 29, 2021.
Application No. PCT/CN2021/103207 is a continuation of application No. PCT/CN2020/098904, filed on Jun. 29, 2020.

(30) Foreign Application Priority Data
Jun. 29, 2020 (CN) PCT/CN2020/098904
Jun. 29, 2021 (CN) PCT/CN2021/103207

(51) Int. Cl. H04W 4/06; H04W 76/40

(52) U.S. Cl. CPC H04W 4/06; H04W 76/40; H04L 12/189

(57) ABSTRACT

Apparatus and methods are provided for reliable multicast transmission with uplink feedback. In one novel aspect, a unicast RB associated with the multicast RB is configured. In one embodiment, a single protocol stack is configured for the UE to receive MBS data packets from both the PTM RB and the PTP RB. The UE assembles data packets from the multicast RB and the unicast RB at the single UE protocol stack and provides uplink feedback for MBS data reception status through the PTP RB. The uplink feedback is provided by the UE RLC entity with RLC status report or by the UE PDCP entity with PDCP status report. The UE is configured with one LCH for the MBS and monitors a multicast LCH through a G-RNTI and a unicast LCH through a C-RNTI. Alternatively, the UE is configured with a multicast LCH and a unicast LCH.

### CROSS REFERENCE TO RELATED APPLICATIONS

This application is filed under 35 U.S.C. § 111(a) and is based on and hereby claims priority under 35 U.S.C. § 120 and § 365(c) from International Application No. PCT/CN2021/103207, titled “Reliable Multicast Transmission with Uplink Feedback,” with an international filing date of Jun. 29, 2021. International Application PCT/CN2021/103207, in turn, claims priority under 35 U.S.C. § 120 and § 365(c) from International Application No. PCT/CN2020/098904, titled “Methods and Apparatus of Reliable Multicast Transmission with Uplink Feedback,” with an international filing date of Jun. 29, 2020. The disclosure of each of the foregoing documents is incorporated herein by reference.

### TECHNICAL FIELD

The disclosed embodiments relate generally to wireless communication, and, more particularly, to reliable multicast transmission with uplink feedback.

### BACKGROUND

With the exponential growth of wireless data services, the content delivery to large mobile user groups has grown rapidly. Initial wireless multicast/broadcast services include streaming services such as mobile TV and IPTV. With the growing demand for large group content delivery, recent application development for mobile multicast services requires highly robust and critical communication services such as group communication in disaster situations and the necessity of public safety network-related multicast services. The early 3GPP in the LTE standard defines enhanced multimedia broadcast multicast services eMBMS. The single-cell point to multipoint (SC-PTM) services and multicast-broadcast single-frequency network (MBSFN) are defined. The fifth generation (5G) multicast and broadcast services (MBS) are defined based on the unicast 5G core (5GC) architecture. A variety of applications may rely on communication over multicast transmission, such as live stream, video distribution, vehicle-to-everything (V2X) communication, public safety (PS) communication, file download, and so on. In some cases, there may be a need for the cellular system to enable reliable multicast transmission to ensure the reception quality at the UE side. Reliability transmission for some multicast services in the NR system requires feedback on the reception of the multicast transmission, which helps the network to perform necessary retransmission of the content to the UE.

Improvements and enhancements are required to support reliable multicast transmission and reception with uplink feedback in the NR network.

### SUMMARY

Apparatus and methods are provided for reliable multicast transmission with uplink feedback. In one novel aspect, a unicast RB associated with the multicast RB is configured for reliable MBS with uplink feedback. In one embodiment, a single protocol stack with one RLC entity and one PDCP entity is configured for the UE to receive MBS data packets from both the PTM RB and the PTP RB. The UE assembles data packets from the multicast RB and the unicast RB at the single UE protocol stack and provides uplink feedback for MBS data reception status through the PTP RB. In one embodiment, the uplink feedback for MBS data reception is sent upon receiving a polling request from the network entity. In one embodiment, the polling request is received on the PTP RB. In one embodiment, the uplink feedback is provided by the UE RLC entity with RLC status report. In another embodiment, the uplink feedback is provided by the UE PDCP entity with PDCP status report. In one embodiment, the UE is configured with one LCH for the MBS and monitors a multicast LCH through a G-RNTI and a unicast LCH through a C-RNTI for downlink data reception. In another embodiment, the UE is configured with a multicast LCH corresponding to the PTM RB and a unicast LCH corresponding to the associated PTP RB corresponds. The multicast LCH and the unicast LCH are independent.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a schematic system diagram illustrating an exemplary NR wireless network that supports reliable multicast transmission for multicast services in a NR network with uplink feedback.

FIG. 2A illustrates an exemplary NR wireless system with centralized upper layers of the NR radio interface stacks and UE stack with multicast protocol and unicast protocol.

FIG. 2B illustrates exemplary top-level functional diagrams for reliable multicast services.

FIG. 3 illustrates exemplary diagrams for the protocol structure supporting reliable multicast with RLC assigned SN and retransmission at the RLC layer.

FIG. 4 illustrates exemplary diagrams for PTM to PTP switch during multicast with RLC assigned SN and retransmission at the RLC layer.

FIG. 5 illustrates exemplary diagrams for the protocol structure supporting reliable multicast with PDCP assigned PDCP SN and retransmission at the RLC layer.

FIG. 6 illustrates exemplary diagrams for PTM to PTP switch during multicast with PDCP assigned PDCP SN and retransmission at the RLC layer.

FIG. 7 illustrates exemplary diagrams for the protocol structure supporting reliable multicast with PDCP assigned PDCP SN and retransmission at the PDCP layer.

FIG. 8 illustrates exemplary diagrams for PTM to PTP switch during multicast with PDCP assigned PDCP SN and retransmission at the PDCP layer.

FIG. 9 illustrates an exemplary flow chart for reliable multicast transmission with uplink feedback.

### DETAILED DESCRIPTION

Reference will now be made in detail to some embodiments of the invention, examples of which are illustrated in the accompanying drawings.

Aspects of the present disclosure provide methods, apparatus, processing systems, and computer readable mediums for NR (new radio access technology, or 5G technology) or other radio access technology. NR may support various wireless communication services, such as enhanced mobile broadband targeting wide bandwidth, millimeter wave targeting high carrier frequency, massive machine type communications targeting non-backward compatible MTC techniques, and/or mission critical targeting ultra-reliable low-latency communications. These services may include latency and reliability requirements. These services may also have different transmission time intervals (TTI) to meet respective quality of service (QoS) requirements. In addition, these services may co-exist in the same subframe.

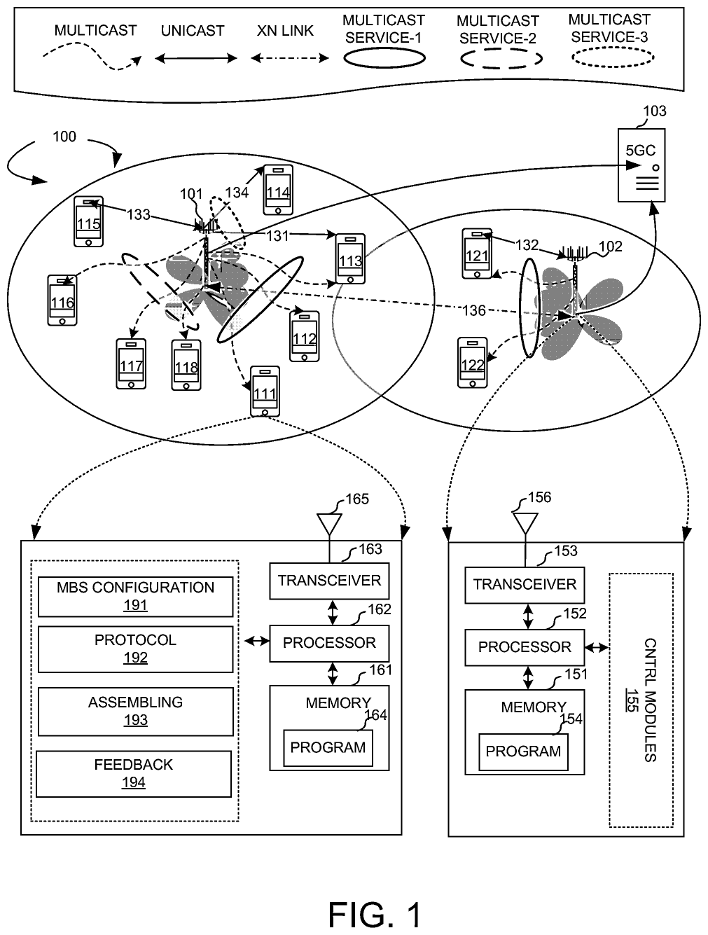

FIG. 1 is a schematic system diagram illustrating an exemplary NR wireless network that supports reliable multicast transmission for multicast services in a NR network with uplink feedback. NR wireless system 100 includes one or more fixed base infrastructure units forming a network distributed over a geographical region. The base unit may also be referred to as an access point, an access terminal, a base station, a Node-B, an eNode-B (eNB), a gNB, or by other terminology used in the art. The network can be homogeneous network or heterogeneous network, which can be deployed with the same frequency or different frequency. gNB 101 and gNB 102 are base stations in the NR network, the serving area of which may or may not overlap with each other. The backhaul connection such as 136, connects the non-co-located receiving base units, such as gNB 101 and gNB 102. These backhaul connections, such as connection 136, can be either ideal or non-ideal. gNB 101 connects with gNB 102 via Xnr interface. The base stations, such as gNB 101 and gNB 102, connects to the 5G core (5GC) network 103 through network interfaces, such as N2 interface for the control plane and N3 interface for the user plane.

NR wireless network 100 also includes multiple communication devices or mobile stations, such as user equipments (UEs) 111, 112, 113, 114, 116, 117, 118, 121 and 122. The UE may also be referred to as mobile station, a mobile terminal, a mobile phone, smart phone, wearable, an IoT device, a table let, a laptop, or other terminology used in the art. The mobile devices can establish one or more unicast connections with one or more base stations. For example, UE 115 has unicast connection 133 with gNB 101. Similarly, UEs 121 connects with gNB 102 with unicast connection 132.

In one novel aspect, one or more radio bearers are established for one or more multicast sessions/services. A multicast service-1 is provided by gNB 101 and gNB 102. UEs 111, 112 and 113 receive multicast services from gNB 101. UEs 121 and 122 receive multicast services from gNB 102. Multicast service-2 is provided by gNB 101 to the UE group of UEs 116, 117, and 118. Multicast service-1 and multicast service-2 are delivered in multicast mode with a multicast radio bearer (MRB) configured by the NR wireless network. The receiving UEs receives data packets of the multicast service through corresponding MRB configured. UE 111 receives multicast service-1 from gNB 101. gNB 102 provides multicast service-1 as well. In one novel aspect, a unicast RB associated with the multicast RB is configured for reliable MBS. UE 121 is configured with multicast service-1. UE 121 is configured multicast RB as well as the unicast RB 132. The associated unicast RB 132 receives MBS data packets together with the multicast RB. The associated unicast RB 132 is used to provide reliable MBS for UE 121. Similarly, UEs 111, 112, and 113 receive multicast service-1 through corresponding multicast RB and/or associated unicast RB. Each UE receiving MBS is also configured with at least one corresponding associated unicast RB for reliability. Similarly, for multicast service-2, UEs 116, 117, and 118 receive multicast service-2 through corresponding multicast RB and/or associated unicast RB. Each UE receiving MBS is also configured with at least one corresponding associated unicast RB for reliability. In one scenario, multicast services are configured with unicast radio bearers. A multicast service-3 is delivered to UE 113 and UE 114 via unicast radio link 131 and 134, respectively. In one embodiment, the MBS delivered through unicast bearer through PTP protocol stack are switched to PTM leg configured for the UE upon detecting predefined events. The gNB, upon detecting one or more triggering event, switches service mode from unicast to multicast using PTM legs.

FIG. 1 further illustrates simplified block diagrams of a base station and a mobile device/UE for multicast transmission. gNB 102 has an antenna 156, which transmits and receives radio signals. An RF transceiver circuit 153, coupled with the antenna, receives RF signals from antenna 156, converts them to baseband signals, and sends them to processor 152. RF transceiver 153 also converts received baseband signals from processor 152, converts them to RF signals, and sends out to antenna 156. Processor 152 processes the received baseband signals and invokes different functional modules to perform features in gNB 102. Memory 151 stores program instructions and data 154 to control the operations of gNB 102. gNB 102 also includes a set of control modules 155 that carry out functional tasks to communicate with mobile stations.

FIG. 1 also includes simplified block diagrams of a UE, such as UE 111. The UE has an antenna 165, which transmits and receives radio signals. An RF transceiver circuit 163, coupled with the antenna, receives RF signals from antenna 165, converts them to baseband signals, and sends them to processor 162. In one embodiment, the RF transceiver may comprise two RF modules (not shown). A first RF module is used for HF transmitting and receiving, and the other RF module is used for different frequency bands transmitting and receiving which is different from the HF transceiver. RF transceiver 163 also converts received baseband signals from processor 162, converts them to RF signals, and sends out to antenna 165. Processor 162 processes the received baseband signals and invokes different functional modules to perform features in UE 111. Memory 161 stores program instructions and data 164 to control the operations of UE 111. Antenna 165 sends uplink transmission and receives downlink transmissions to/from antenna 156 of gNB 102.

The UE also includes a set of control modules that carry out functional tasks. These control modules can be implemented by circuits, software, firmware, or a combination of them. A MBS configuration module 191 configures an MBS with a network entity in the wireless network, wherein the MBS is configured with a point-to-multipoint (PTM) radio bearer (RB) and an associated point-to-point (PTP) RB. A protocol module 192 establishes a single UE protocol stack with one UE radio link control (RLC) entity and one UE packet data convergence protocol (PDCP) entity to receive data packets from both the PTM RB and the associated PTP RB. An assembling module 193 assembles data packets from the multicast RB and the unicast RB at the single UE protocol stack. A feedback module 194 provides uplink feedback for MBS data reception status through the PTP RB using a cell radio network temporary identifier (C-RNTI).

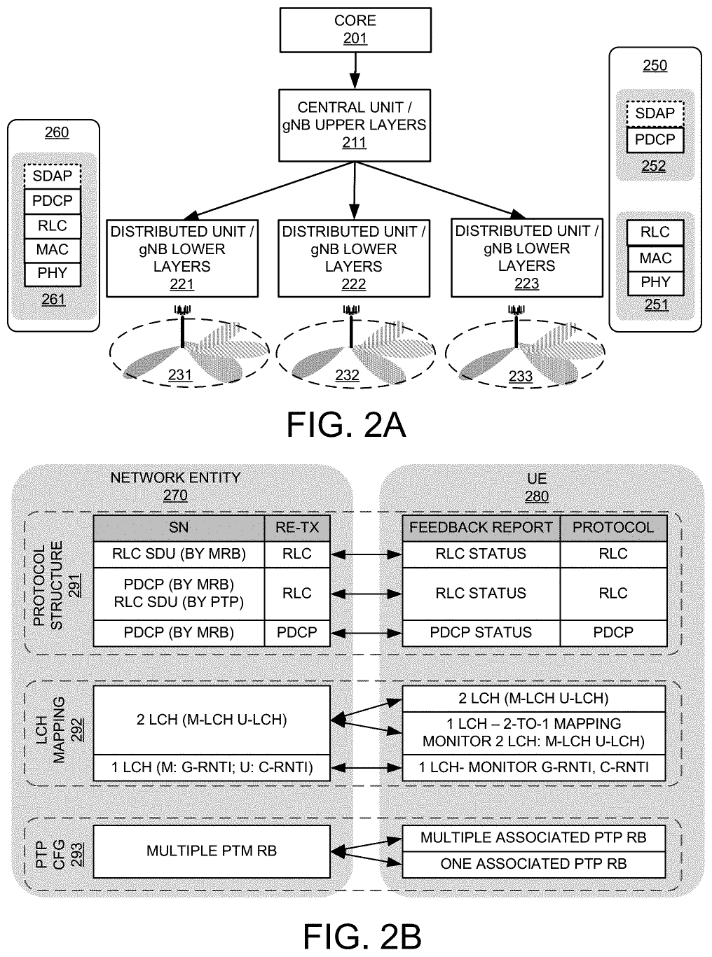

FIG. 2A illustrates an exemplary NR wireless system with centralized upper layers of the NR radio interface stacks and UE stack with multicast protocol and unicast protocol. Different protocol split options between central unit (CU) and distributed unit (DU) of gNB nodes may be possible. The functional split between the CU and DU of gNB nodes may depend on the transport layer. Low performance transport between the CU and DU of gNB nodes can enable the higher protocol layers of the NR radio stacks to be supported in the CU, since the higher protocol layers have lower performance requirements on the transport layer in terms of bandwidth, delay, synchronization, and jitter. In one embodiment, SDAP and PDCP layer are located in the CU, while RLC, MAC and PHY layers are located in the DU. A core unit 201 is connected with one central unit 211 with gNB upper layer 252. In one embodiment 250, gNB upper layer 252 includes the PDCP layer and optionally the SDAP layer. Central unit 211 connects with distributed units 221, 222, and 221. Distributed units 221, 222, and 223 each corresponds to a cell 231, 232, and 233, respectively. The DUs, such as 221, 222 and 223 includes gNB lower layers 251. In one embodiment, gNB lower layers 251 include the PHY, MAC and the RLC layers. In another embodiment 260, each gNB has the protocol stacks 261 including SDAP, PDCP, RLC, MAC and PHY layers.

FIG. 2B illustrates exemplary top-level functional diagrams for reliable multicast services. A UE 280 is configured with one or more MBS with a network entity 270, such as a gNB. The network needs to establish one or multiple radio bearers (RBs) corresponding to the multicast flows of a particular multicast session in order to support the multicast transmission in the downlink over the air. The multiple RBs can be subject to Point-to-Multiple (PTM) or Point-to-Point (PTP) transmission within a cell. For the PTM transmission, the multicast RB is a PTM RB. For the PTP transmission, the unicast RB is a PTP RB. In one novel aspect, a single UE combined protocol stack is configured for data reception from both the PTM RB and the associated PTP RB. In one embodiment 291, the UE single protocol stack structure with the corresponding configuration at the network entity is provided. In another embodiment 292, the UE logic channel (LCH) configuration corresponding to the LCH configuration for the MBS at the network entity are provided. In yet another embodiment 283, multiple MBS sessions with multiple PTM RBs configurations are provided.

In one embodiment 291, a single protocol stack is configured for data reception from both the multicast RB and the unicast RB. This signal protocol stack also carries the uplink feedback channel. The UE single protocol stack is configured with one radio link control (RLC) entity and one packet data convergence protocol (PDCP) entity.

In one embodiment, the uplink feedback for MBS data reception is sent upon receiving a polling request from the network entity, and wherein the polling request is received on the PTP RB. In a first scenario, RLC sequence number (SN) of data packets received from the PTM RB and the PTP RB are both assigned by an RLC TX-only entity at network entity 270. The RLC SN for data packets received from the PTM RB and PTP RB are aligned. The RLC service data unit (SDU) SN is assigned by the RLC TX-only entity for the multicast. The uplink feedback for MBS data reception is an RLC status provided by the UE RLC entity. The retransmission, data buffering, and data discarding are performed by the RLC entities for corresponding UEs at network entity 270. In a second scenario, the PDCP entity of network entity 270 assigns PDCP sequence number (SN) for MBS data packets and the RLC entity of the PTP RB assigns the RLC SDU SN for MBS data packets. PDCP SN of data packets received from the PTM RB and the PTP RB are both assigned by a PDCP entity at the network entity. The UE RLC entity separates data packets from the PTM RB from the PTP RB before delivering to the UE PDCP entity. The retransmission, data buffering, and data discarding are performed by the RLC entities for corresponding UEs at network entity 270. UE 280, correspondingly, is configured with one UE RLC entity to receive data packets from the PTM RB and the PTP RB. In a third scenario, the PDCP entity of network entity 270 assigns PDCP sequence number (SN) for MBS data packets. The retransmission, data buffering, and data discarding are performed by the PDCP entities for corresponding UEs at network entity 270. UE 280, correspondingly, is configured with one UE PDCP entity and one RLC entity to receive data packets from the PTM RB and the PTP RB. The UE PDCP entity provides PDCP status report as the feedback.

In one embodiment 292, logic channels are configured for the MBS. In one embodiment, UE 280 is configured with one LCH for the MBS, and wherein the UE monitors a multicast LCH through a group RNTI (G-RNTI) and a unicast LCH through a cell RNTI (C-RNTI) for downlink data reception. In another embodiment, the UE is configured with a multicast LCH corresponding to the PTM RB and a unicast LCH corresponding to the associated PTP RB corresponds, and wherein the multicast LCH and the unicast LCH are independent. From the logical channel modeling perspective, there are different alternatives. In the first alternative, network entity 270 establishes two logical channels (with one for PTM data flow and the other for PTP data flow) for reliable multicast transmission. In this case, UE 280 monitors two independent logical channels (LCHs) for downlink data reception. UE 280 is configured to establish two independent logical channels. UE 280 delivers the data packets received from the two LCHs to the same RLC entity for succeeding handling. In the second alternative, network entity 270 establishes two logical channels (with one for PTM data flow and the other for PTP data flow) for reliable multicast transmission. UE 280 is configured to establish only one logical channel. UE 280 monitors two independent logical channels (LCHs) for downlink data reception. There is a two-to-one mapping for the downlink logical channels. UE 280 delivers the data packets received from the two LCHs to the same RLC entity for succeeding handling. In the third alternative, network entity 270 establishes a single logical channel (for both PTM data flow and PTP data flow) for reliable multicast transmission. Network entity 270 schedules the downlink transmission (from either PTM data flow or PTP data flow) at the same logical channel but use different RNTI to indicate. PTM transmission block is indicated by G-RNTI and PTP transmission block is indicated by C-RNTI. In this case, UE 280 monitors single logical channel (LCH) for downlink data reception. UE 280 delivers the data packets received from the LCH to the RLC entity for succeeding handling.

In one embodiment 293, multiple MBS sessions are configured for UE 270. UE 270 is further configured with multiple MBSs, each configured with a multicast RB with corresponding G-RNTI. In one embodiment, the UE is configured with multiple associated unicast PTP RLC channels for each multicast RBs. In another embodiment, the UE is configured with one associated unicast PTP RLC channel for all multicast RBs.

The general principle of reliable multicast transmission is that, in network side, there is a separate unicast RLC channel or unicast Radio Bearer (in RLC AM mode) established to assist the reliable multicast transmission. Both unicast RLC channel and unicast radio bearer can be seen as an associated PTP RB for the corresponding PTM RB. The L2 entity (RLC and/or PDCP) for unicast channel or unicast Radio Bearer (i.e., RB) is separated from PTM RB (in RLC UM mode). Initial transmission of the multicast data is carried by PTM RB and is multicast to multiple UEs using G-RNTI. Any retransmissions if needed is carried by the associated PTP RB (the associated RLC channel or unicast Radio Bearer) and is unicast to the UE using C-RNTI. Alternatively, the network may perform multicast retransmission (e.g., blindly or based on the feedback from the UEs) over PTM RB, and the additional retransmissions (if needed) is unicast over the associated RLC channel (or unicast RB) to the UE using C-RNTI. In downlink, the associated RLC channel (or unicast RB) can be also used for polling request to trigger a specific UE to feedback its reception status of the L2 packets. In downlink, the PTM RB can be used for Polling Request if the Base Station intends to trigger all of the concerned UEs to feedback its reception status of the L2 packets. To support the reliable transmission for NR multicast service, a feedback channel in the uplink is configured for each UE receiving the multicast service. The receiving UE sends feedback regarding its reception status about the multicast service through the feedback channel to the network. Based on the feedback, the network may perform necessary retransmission to improve the transmission reliability. From uplink feedback perspective, the feedback channel may be used for L2 feedback (e.g., RLC Status Report and/or PDCP Status Report). In addition, the feedback channel may be used for HARQ feedback. Furthermore, the feedback should be a bidirectional channel between the UE and the network, with the assumption that the network may take that channel to perform needed packet retransmission. The said packet retransmission is L2 retransmission (e.g., RLC retransmission and/or PDCP retransmission). In addition, the feedback channel may be used for HARQ retransmission.

In one novel aspect, there is single or combined protocol stack established for the reception of the multicast data (carried by PTM Radio Bearer) and the unicast data (carried over the unicast channel or unicast Radio Bearer). The RLC entity of the protocol stack in UE side for the reception of the reliable multicast transmission is in RLC AM mode. This protocol stack in UE side represents a protocol stack for air interface-based transmission of a dedicated data RB (i.e., DRB). In uplink, the associated RLC channel (or unicast Radio Bearer) is used to provide the uplink feedback using C-RNTI e.g., L2 status report (RLC or PDCP). UE monitors two independent packet data flows (with one for PTM data and the other for PTP data) through different RNTIs. UE assembles the data packets from two data flows at RLC/PDCP. This operation is based on the corresponding handling at network side, where the Sequence Numbering of the packets (regardless of PTP or PTM) is aligned.

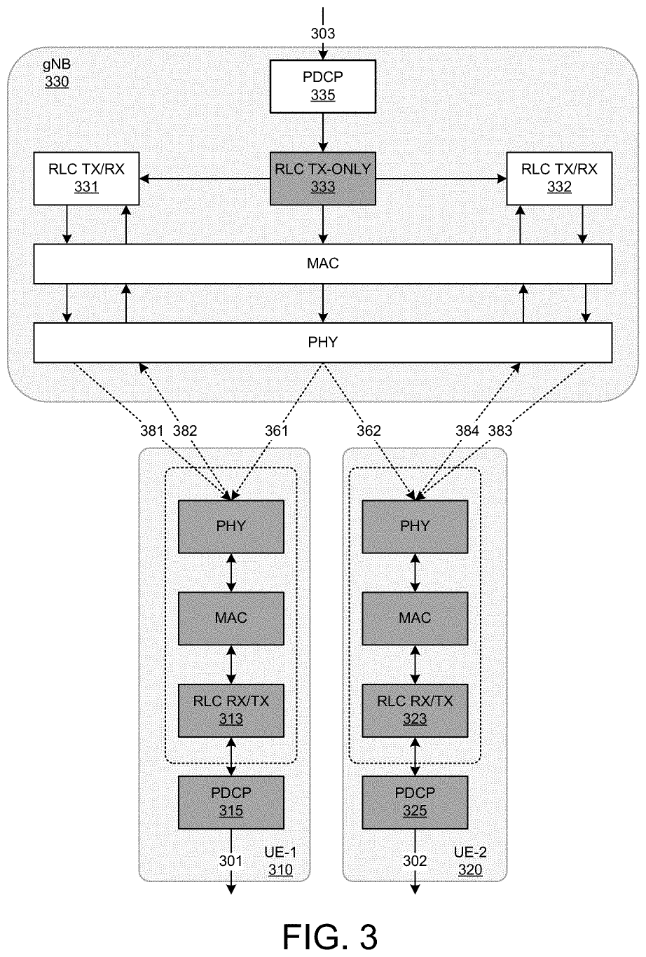

FIG. 3 illustrates exemplary diagrams for the protocol structure supporting reliable multicast with RLC assigned SN and retransmission at the RLC layer. UE-1 310 and UE-2 320 are configured with an MBS. UE-1 310 and UE-2 320 are each configured with a single/combined protocol for MBS data reception and uplink feedback. UE-1 310 single protocol stack includes a PHY, a MAC, an RLC entity 313, and a PDCP entity 315. UE-2 320 single protocol stack includes a PHY, a MAC, an RLC entity 323, and a PDCP entity 325. Each corresponding single protocol stack of UE-1 310 and UE-2 320 processes the received MBS data packets and passes to upper layer as UE reception 301 and 302, respectively. An exemplary network entity, gNB 330, transmits one or more the multicast flows 303 within an MBS to one or more UEs, such as UE-1 310 and UE-2 320. The MBS from gNB 330 is configured with a PTM RB to UE-1 310 and UE-2 320 through 361 and 362, respectively. Associated PTP RB with DL 381 and UL feedback 382 is configured for UE-1 310. Associated PTP RB with DL 383 and UL feedback 384 is configured for UE-2 320.

At network entity, gNB 330, PTM RB is used for downlink (DL) multicast transmission with passed from PDCP entity 335 to RLC TX-only entity 333, and its RLC mode is UM mode. Specific to UE-1 and UE-2, an associated unicast RLC channel, with RLC entity 331 and RLC entity 332, is established respectively for downlink RLC packet retransmission and uplink RLC status report. The network can also send the Polling Request to the UE to ask the UE, UE-1 310 and/or UE-2 320, to provide RLC status Report on the reception of the PTM RB. In one embodiment, the downlink multicast transmission can be one or more PTM RBs, with each corresponding to an independent logical channel (e.g., multicast traffic channel, MTCH). Each multicast channel is scheduled by a specific G-RNTI at PDCCH. The network can establish one associated unicast RLC channel for each PTM RB that the UE receives. In another embodiment, the network can establish one associated unicast RLC channel for all PTM RBs that the UE receives. The RLC entity of PTM RB (i.e., the RLC TX-only entity 333) is responsible for the SN allocation for the RLC packets. RLC TX-only entity 333 makes multicast delivery via PTM RB. RLC TX-only entity 333 delivers a copy of all the RLC packets (with RLC SN) to the RLC TX/RX entity 331 of UE-1 and RLC TX/RX entity 332 of UE-2 in the network side. The RLC TX/RX entity 331 of UE-1 and 332 of UE-2 (buffer the RLC packets until positive packet status report received. RLC TX/RX entity 313 of UE-1 and 323 of UE-2 provide RLC status report to network when polling request is received via the corresponding unicast leg. RLC TX/RX entity 331 of UE-1 and 332 of UE-2 remove the RLC packets when positive packet status report received. RLC TX/RX entity 331 of UE-1 and 332 of UE-2 discard the RLC packets based on a discard timer to avoid too long buffering for the packets. The discard timer can be per packet. Alternatively, the discarding of the RLC packets can be performed according to a configured window that defines the number of RLC SDUs can be buffered. For example, the new RLC packets coming may trigger the discarding of the previous RLC packets, which follows the principle of first-in-first-out (FIFO) if the window reaches the limitation.

In one novel aspect, one single/combined protocol stack is configured by the UE for both the PTM and PTP data receptions. There is a single protocol stack for the reception of the PTM RB and the PTP RB. In uplink, the associated RLC channel sends RLC feedback (i.e., RLC Status Report) to PTP RB. The RLC feedback acknowledges the reception status of both initial transmission and retransmission. UE monitors UE specific PDCCH using C-RNTI and read the potential scheduling information for PTP RB. At the same time, the UE monitors multicast PDCCH using G-RNTI and reads the potential scheduling information for PTM RB. The PTP RB is carried by dedicated traffic logical channel (i.e., DTCH). PTM RB is carried by MTCH. The UE receives data packets from the multicast RB and the unicast RB at the single UE protocol stack. The UE assembles the data packets from two independent data flows at RLC/PDCP. This operation is based on the corresponding handling at network side, where the SNs of the packets, regardless of PTP or PTM, are aligned.

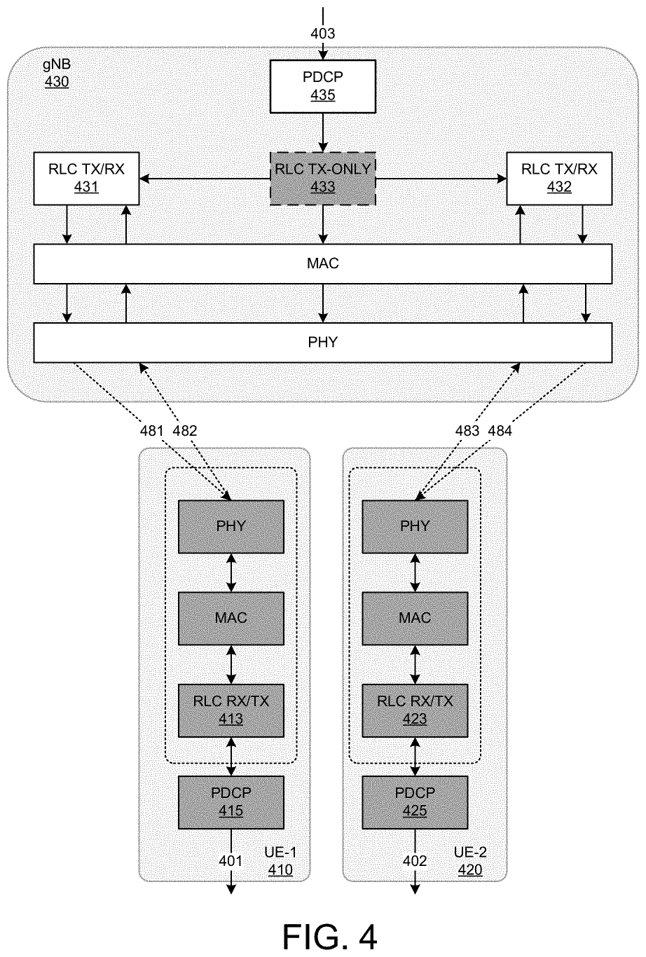

FIG. 4 illustrates exemplary diagrams for PTM to PTP switch during multicast with RLC assigned SN and retransmission at the RLC layer. UE-1 410 and UE-2 420 are configured with an MBS. UE-1 410 and UE-2 420 are each configured with a single/combined protocol for MBS data reception and uplink feedback. UE-1 410 single protocol stack includes a PHY, a MAC, an RLC entity 413, and a PDCP entity 415. UE-2 420 single protocol stack includes a PHY, a MAC, an RLC entity 423, and a PDCP entity 425. Each corresponding single protocol stack of UE-1 410 and UE-2 420 processes the received MBS data packets and passes to upper layer as UE reception 401 and 402, respectively. An exemplary network entity, gNB 430, transmits one or more the multicast flows 403 within an MBS to one or more UEs, such as UE-1 410 and UE-2 420. Associated PTP RB with DL 481 and UL feedback 482 is configured for UE-1 410. Associated PTP RB with DL 483 and UL feedback 484 is configured for UE-2 420. Originally, a PTM RB is configured to carry the MBS data packets to one or more UEs, such as UE-1 410 and UE-2 420. gNB 430 is configured with PDCP 435, a RLC TX-only entity 433, RLC entity for PTP, such as RLC 431 for UE-1 410 and RLC 432 for UE-2 420. gNB 430 protocol further includes the MAC and PHY layers.

In one scenario, the MBS data packets switch from the PTM RB to the associated PTP RB. The PTM RB leg is deactivated when one or more preconfigured or predefined triggering events is detected to switch the PTM to PTP. In on embodiment, the triggering event is the number of UEs receiving the multicast service is below a predefined threshold. In UE side, after PTM to PTP switch, the UE only monitors the unicast logical channel via C-RNTI. During PTM to PTP switch, the UE reception protocol stack does not change. From network side, the upper part of RLC functionality of RLC TX-only entity 433 is kept so that the RLC SN is still allocated by RLC TX only entity to ensure consistent RLC SN allocation after PTM to PTP. In another embodiment, the RLC TX-only entity 433 is removed and the PDCP entity 435 directly delivers the packets to RLC TX/RX entity 431 of UE-1 and 432 of UE-2. In another embodiment, the RLC TX-only 431 and PDCP entity 435 (for multicast RB) is removed. A separate PDCP for unicast, not shown, is established at network side to delivers the packets in unicast manner. In both embodiments, the SN numbering of RLC is restarted at network side. The UE side RLC entity, RLC 413 and RLC 423, are reset. In another embodiment, the RLC SN numbering of the PTM RLC entity 431 is inherited at the newly established unicast RLC entity, such as RLC 431 and 432. The SN numbering is not restarted, and no reset is needed at the UE side. During the PTM to PTP transmission mode switch, from security configuration (i.e., ciphering/integrity protection) perspective, a common security configuration is applied to both PTM RB and PTP RB for multicast transmission. The security setting is inherited after transmission mode switch. In another embodiment, the PTP RB disables the ciphering/integrity protection, or just use nia0 and/or nea0.

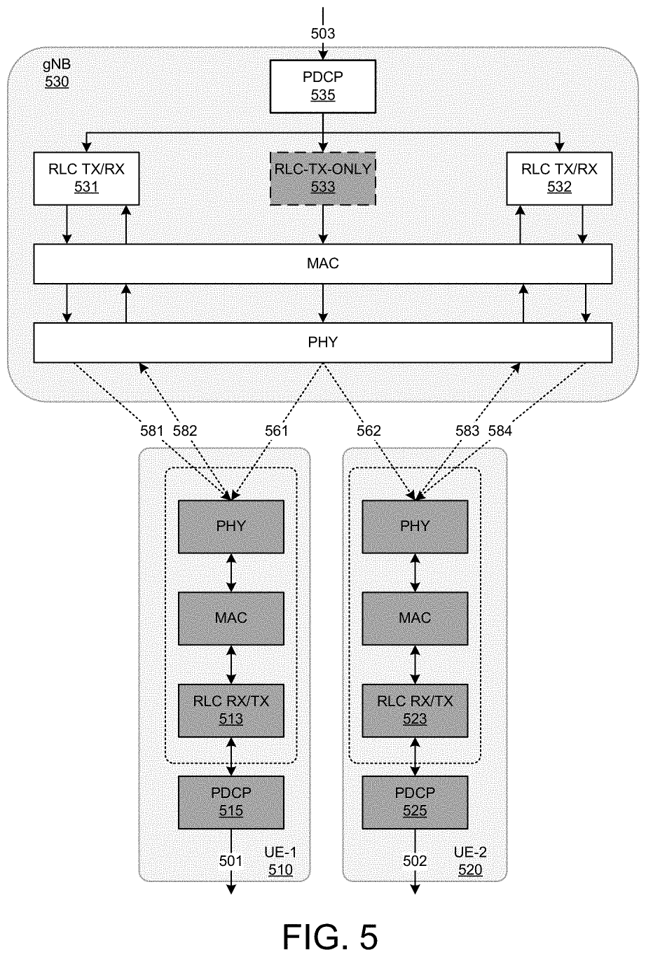

FIG. 5 illustrates exemplary diagrams for the protocol structure supporting reliable multicast with PDCP assigned PDCP SN and retransmission at the RLC layer. UE-1 510 and UE-2 520 are configured with an MBS. UE-1 510 and UE-2 520 are each configured with a single/combined protocol for MBS data reception and uplink feedback. UE-1 510 single protocol stack includes a PHY, a MAC, an RLC entity 513, and a PDCP entity 515. UE-2 520 single protocol stack includes a PHY, a MAC, an RLC entity 523, and a PDCP entity 525. Each corresponding single protocol stack of UE-1 510 and UE-2 520 processes the received MBS data packets and passes to upper layer as UE reception 501 and 502, respectively. An exemplary network entity, gNB 530, transmits one or more the multicast flows 503 within an MBS to one or more UEs, such as UE-1 510 and UE-2 520. The MBS from gNB 530 is configured with a PTM RB to UE-1 510 and UE-2 520 through 561 and 562, respectively. Associated PTP RB with DL 581 and UL feedback 582 is configured for UE-1 510. Associated PTP RB with DL 583 and UL feedback 584 is configured for UE-2 520.

Network PDCP entity 535 allocates the SN of PDCP packets and make multicast delivery via PTM RB. The PDCP entity 535 sends the copy of all of the PDCP packets with PDCP header to the RLC TX/RX entity 531 of UE-1 and 532 of UE-2 in the network side. The RLC TX/RX entity 531 of UE-1 and 532 of UE-2 buffer the RLC packets until positive packet status report received for the corresponding RLC packets. RLC TX/RX entity 513 of UE-1 and 523 of UE-2 provide RLC status report to network when polling request is received. The polling request can be sent via either multicast RB or unicast RB. The RLC TX/RX entity 513 of UE-1 and 523 of UE-2 separate the packets coming from unicast PTP RB and multicast PTM RB after MAC demultiplexing operation due to the isolated RLC SN numbering for the RLC packets. The RLC TX/RX entity 531 of UE-1 and 532 of UE-2 remove the RLC packets when positive packet status report received. RLC TX/RX entity 531 of UE-1 and 532 of UE-2 follow the same discard mechanism as described in FIG. 3.

In one embodiment, the RLC status report from the UE specific information, such as logical channel ID, bearer ID, or other identity information, are inserted into the RLC status report to indicate which leg (i.e., multicast PTM leg and/or unicast PTP leg) the RLC status report applies. The multicast PTM leg and the unicast PTP leg have independent RLC entities and the packets coming from PDCP entity is subject to different RLC SN allocation. In another embodiment, if a particular RLC status report is received by gNB 530 on the PTM RB, gNB 530 asks the associated unicast RLC entity to perform retransmission based on negative acknowledgement. The RLC SDU buffered at the associated unicast RLC entity, such as RLC TX/RX entity 531 and/or 532, is based on the PDCP SN, instead of RLC SN. For example, if the PDCP packet (with PDCP SN #1000) is segmented into multiple RLC packets, the whole PDCP packet needs to be retransmitted in case of one missing RLC segments. In another embodiment, the RLC entities for associated PTP, such as RLC entity 531 and 532, always use the PDCP SN as allocated by the PDCP entity 535 as the RLC SN. An aligned SN length between RLC entity and PDCP entity is configured. The SN is aligned between the multicast leg and the unicast leg. The RLC status report uses the PDCP SN and there is no need for RLC status report to carry transmission leg information.

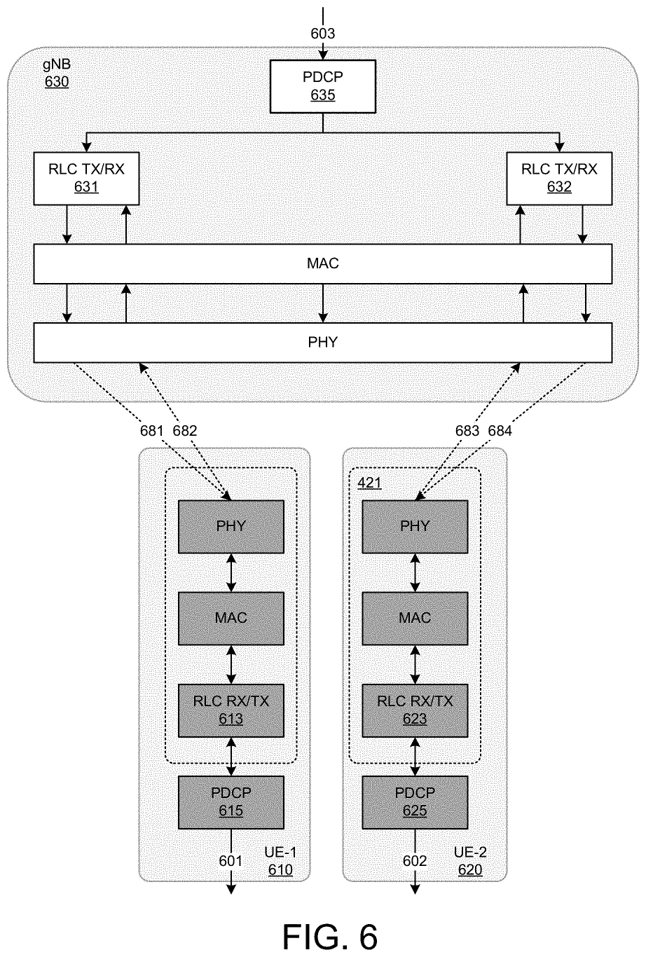

FIG. 6 illustrates exemplary diagrams for PTM to PTP switch during multicast with PDCP assigned PDCP SN and retransmission at the RLC layer. UE-1 610 and UE-2 620 are configured with an MBS. UE-1 610 and UE-2 620 are each configured with a single/combined protocol for MBS data reception and uplink feedback. UE-1 610 single protocol stack includes a PHY, a MAC, an RLC entity 613, and a PDCP entity 615. UE-2 620 single protocol stack includes a PHY, a MAC, an RLC entity 623, and a PDCP entity 625. Each corresponding single protocol stack of UE-1 610 and UE-2 620 processes the received MBS data packets and passes to upper layer as UE reception 601 and 602, respectively. An exemplary network entity, gNB 630, transmits one or more the multicast flows 603 within an MBS to one or more UEs, such as UE-1 610 and UE-2 620. Associated PTP RB with DL 681 and UL feedback 682 is configured for UE-1 610. Associated PTP RB with DL 683 and UL feedback 684 is configured for UE-2 620. gNB 630 stack includes PDCP entity 635, and RLC entities for associated PTP, such as RLC 631 for UE-1 610 and RLC 632 for UE-2 620.

In one embodiment, the MBS data packets switch from the PTM RB to the associated PTP RB. The RLC TX-only entity is no longer needed after the switch from PTM RB to PTP RB. In one embodiment, the PDCP entity 635 for multicast RB is kept to make the PDCP SN consistent after the switch. In another embodiment, the PDCP entity 635 for multicast RB is removed and a separate PDCP for unicast, not shown, is established at network side to delivers the packets in unicast manner. In this option, the SN numbering is restarted at network side, then in UE side. In one embodiment, the PDCP entity resets. In another embodiment, the PDCP SN numbering of the PTM PDCP entity is inherited at the newly established unicast PDCP entity at network side. There is no need to reset the PDCP entities.

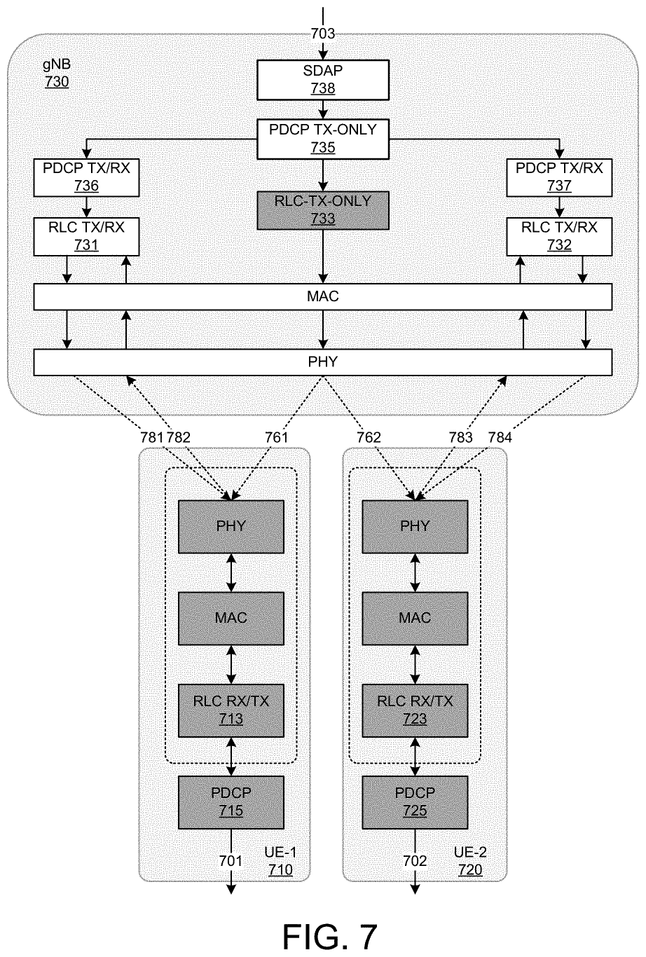

FIG. 7 illustrates exemplary diagrams for the protocol structure supporting reliable multicast with PDCP assigned PDCP SN and retransmission at the PDCP layer. UE-1 710 and UE-2 720 are configured with an MBS. UE-1 710 and UE-2 720 are each configured with a single/combined protocol for MBS data reception and uplink feedback. UE-1 710 single protocol stack includes a PHY, a MAC, an RLC entity 713, and a PDCP entity 715. UE-2 720 single protocol stack includes a PHY, a MAC, an RLC entity 723, and a PDCP entity 725. Each corresponding single protocol stack of UE-1 710 and UE-2 720 processes the received MBS data packets and passes to upper layer as UE reception 701 and 702, respectively. An exemplary network entity, gNB 730, transmits one or more the multicast flows 703 within an MBS to one or more UEs, such as UE-1 710 and UE-2 720. The MBS from gNB 730 is configured with a PTM RB to UE-1 710 and UE-2 720 through 761 and 762, respectively. Associated PTP RB with DL 781 and UL feedback 782 is configured for UE-1 710. Associated PTP RB with DL 783 and UL feedback 784 is configured for UE-2 720.

In one embodiment, PDCP SN of data packets received from the PTM RB and the PTP RB are both assigned by a PDCP entity at the network entity. Network entity, gNB 730 is configured with a SDAP 738, a PDCP TX-only entity 735, one or more PDCP TX/RX entities, such as PDCP TX/RX entity 736 for UE-1 710 and PDCP TX/RX entity 737 for UE-2 720. The PDCP RLC retransmission functionality is enforced at PDCP layer. The PDCP entity 735 in the network side allocates the SN of PDCP packets and make multicast delivery via PTM RB. The PDCP entity 735 sends the copy of all of the PDCP packets with PDCP SN to the PDCP TX/RX entity 736 of UE-1 and 737 of UE-2. PDCP TX/RX entity 736 of UE-1 and 737 of UE-2 only implement the part of the PDCP functionality (i.e., SN allocation is not needed). PDCP TX/RX entity 736 of UE-1 and 737 of UE-2 buffer the PDCP packets until positive packet status report received for the corresponding PDCP packets. PDCP TX/RX entity 715 of UE-1 and 725 of UE-2 provide PDCP status report to network when polling request is received via the corresponding unicast leg. RLC TX/RX entity 713 of UE-1 and 723 of UE-2 separate the packets coming from unicast LCH and multicast LCH before delivers to PDCP. PDCP TX/RX entity 736 of UE-1 and 737 of UE-2 remove the PDCP packets (PDCP PDU) when positive packet status report received. PDCP TX/RX entity 736 of UE-1 and 737 of UE-2 discard the PDCP packets based on the same discard mechanism as described for the example in FIG. 3.

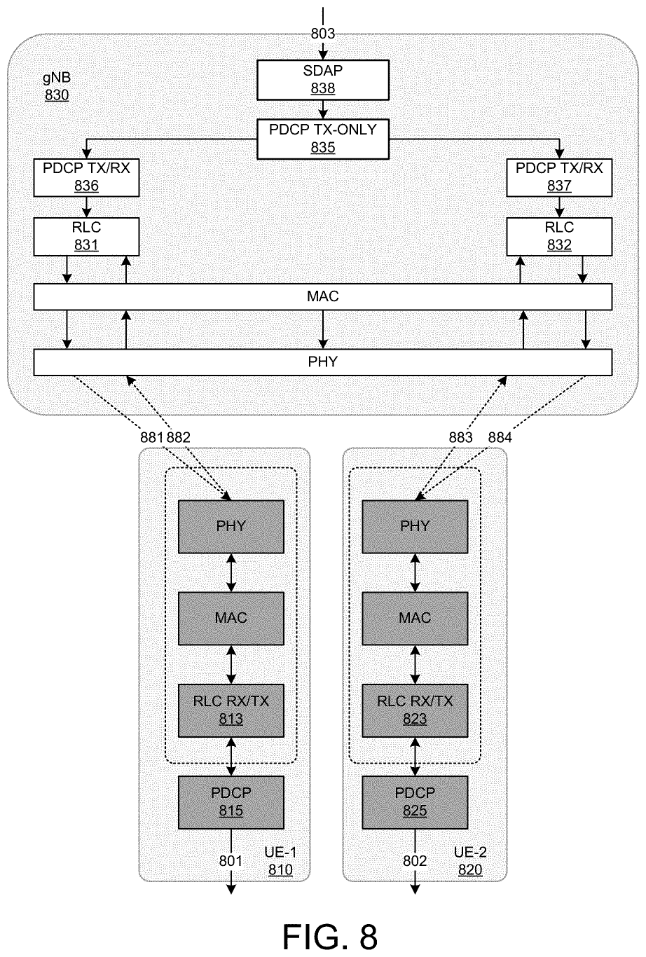

FIG. 8 illustrates exemplary diagrams for PTM to PTP switch during multicast with PDCP assigned PDCP SN and retransmission at the PDCP layer. UE-1 810 and UE-2 820 are configured with an MBS. UE-1 810 and UE-2 820 are each configured with a single/combined protocol for MBS data reception and uplink feedback. UE-1 810 single protocol stack includes a PHY, a MAC, an RLC entity 813, and a PDCP entity 815. UE-2 820 single protocol stack includes a PHY, a MAC, an RLC entity 823, and a PDCP entity 825. Each corresponding single protocol stack of UE-1 810 and UE-2 820 processes the received MBS data packets and passes to upper layer as UE reception 801 and 802, respectively. An exemplary network entity, gNB 830, transmits one or more the multicast flows 803 within an MBS to one or more UEs, such as UE-1 810 and UE-2 820. The MBS from gNB 830 is configured with a PTM RB to UE-1 810 and UE-2 820 through 861 and 862, respectively. Associated PTP RB with DL 881 and UL feedback 882 is configured for UE-1 810. Associated PTP RB with DL 883 and UL feedback 884 is configured for UE-2 820.

In one embodiment, the MBS data packets switch from the PTM RB to the associated PTP RB. After the PTM RB to PTP RB switch, gNB 830 is configured with the SDAP 838, PDCP TX-only entity 835, one or more PDCP entities for each UEs, such as PDCP TX/RX entity 836 for UE-1 810 and PDCP TX/RX entity 837 for UE-2 820. gNB 830 is also configured with one or more RLC entities for each UEs, such as RLC TX/RX entity 831 for UE-1 810 and RLC TX/RX entity 832 for UE-2 820. The upper part of PDCP functionality of PDCP TX-only entity is kept at network side. In one embodiment, the PDCP TX-only entity 835 is removed and the SDAP 838 of multicast RB directly delivers the packets PDCP TX/RX entity 836 for UE-1 810 and PDCP TX/RX entity 837 for UE-2 820. The SN numbering is restarted at network side. At the UE side, the PDCP entity also resets. In another embodiment, the PDCP SN numbering of the PTM PDCP entity is inherited at the newly established unicast PDCP entity at network side. There is no reset needed.

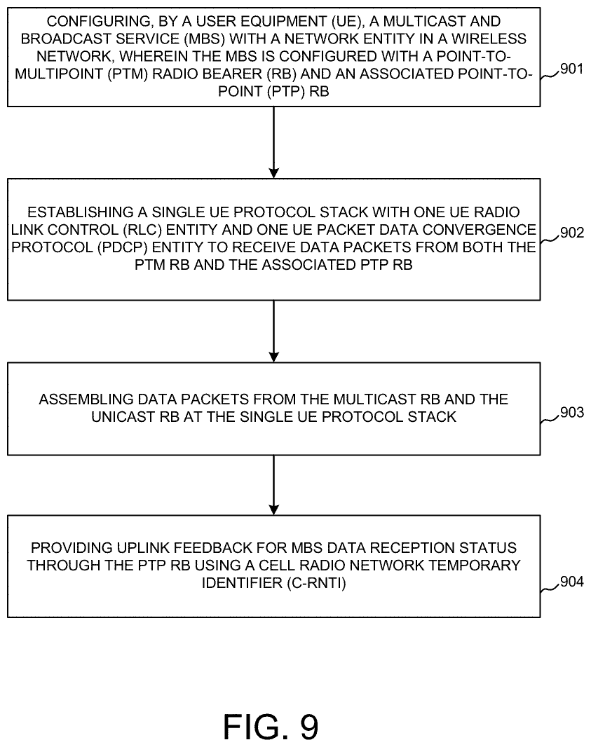

FIG. 9 illustrates an exemplary flow chart for reliable multicast transmission with uplink feedback. At step 901, the UE configures an MBS with a network entity in a wireless network, wherein the MBS is configured with a PTM RB and an associated PTP RB. At step 902, the UE establishes a single UE protocol stack with one UE RLC entity and one UE PDCP entity to receive data packets from both the PTM RB and the associated PTP RB. At step 903, the UE assembles data packets from the multicast RB and the unicast RB at the single UE protocol stack. At step 904, the UE provides uplink feedback for MBS data reception status through the PTP RB using C-RNTI.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
configuring, by a user equipment (UE), a multicast and broadcast service (MBS) with a network entity in a wireless network, wherein the MBS is configured with a point-to-multipoint (PTM) radio bearer (RB) and an associated point-to-point (PTP) RB;
establishing a single UE protocol stack with one UE radio link control (RLC) entity and one UE packet data convergence protocol (PDCP) entity to receive data packets from both the PTM RB and the associated PTP RB;
assembling data packets from the multicast RB and the unicast RB at the single UE protocol stack; and
providing uplink feedback for MBS data reception status through the PTP RB using a cell radio network temporary identifier (C-RNTI).

2. The method of claim 1, wherein the uplink feedback for MBS data reception is sent upon receiving a polling request from the network entity, and wherein the polling request is received on the PTP RB.

3. The method of claim 1, wherein RLC sequence number (SN) of data packets received from the PTM RB and the PTP RB are both assigned by an RLC TX-only entity at the network entity, and wherein the RLC SN for data packets received from the PTM RB and PTP RB are aligned.

4. The method of claim 3, wherein the uplink feedback for MBS data reception is an RLC status provided by the UE RLC entity.

5. The method of claim 3, further comprising:
switching from a multicast mode to a unicast mode for the MBS, wherein the RLC TX-only entity of the network entity is removed, and wherein the RLC SN is restarted;
resetting the UE RLC entity; and
stopping monitoring the PTM RB for MBS data reception.

6. The method of claim 1, wherein PDCP SN of data packets received from the PTM RB and the PTP RB are both assigned by a PDCP entity at the network entity.

7. The method of claim 6, wherein the UE RLC entity separates data packets from the PTM RB from the PTP RB before delivering to the UE PDCP entity.

8. The method of claim 6, wherein a PDCP entity at the network entity performs data retransmission for MBS data packets, and wherein the uplink feedback for MBS data reception is a PDCP status provided by the UE PDCP entity.

9. The method of claim 6, wherein an RLC entity at the network entity performs data retransmission for MBS data packets, and wherein the uplink feedback for MBS data reception is an RLC status provided by the UE RLC entity.

10. The method of claim 3, further comprising:
switching from a multicast mode to a unicast mode for the MBS, wherein the PDCP SN is restarted;
resetting the UE PDCP entity; and
stopping monitoring the PTM RB for MBS data reception

11. The method of claim 1, wherein the UE is configured with one logic channel (LCH) for the MBS, and wherein the UE monitors a multicast LCH through a group RNTI (G-RNTI) and a unicast LCH through a cell RNTI (C-RNTI) for downlink data reception.

12. The method of claim 1, wherein the UE is configured with a multicast LCH corresponding to the PTM RB and a unicast LCH corresponding to the associated PTP RB corresponds, and wherein the multicast LCH and the unicast LCH are independent.

13. The method of claim 1, wherein the UE is further configured with multiple MBSs, each configured with a multicast RB with corresponding G-RNTI.

14. The method of claim 13, wherein the UE is configured with multiple associated unicast PTP RLC channels for each multicast RBs.

15. The method of claim 13, wherein the UE is configured with one associated unicast PTP RLC channel for all multicast RBs.

16. A user equipment (UE), comprising:
a transceiver that transmits and receives radio frequency (RF) signal in a wireless network;
a multicast and broadcast service (MBS) configuration module that configures an MBS with a network entity in the wireless network, wherein the MBS is configured with a point-to-multipoint (PTM) radio bearer (RB) and an associated point-to-point (PTP) RB;
a protocol module that establishes a single UE protocol stack with one UE radio link control (RLC) entity and one UE packet data convergence protocol (PDCP) entity to receive data packets from both the PTM RB and the associated PTP RB;
an assembling module that assembles data packets from the multicast RB and the unicast RB at the single UE protocol stack; and
a feedback module that provides uplink feedback for MBS data reception status through the PTP RB using a cell radio network temporary identifier (C-RNTI).

17. The UE of claim 16, wherein the uplink feedback for MBS data reception is sent upon receiving a polling request from the network entity, and wherein the polling request is received on the PTP RB.

18. The method of claim 16, wherein the UE RLC entity provides RLC status report to the network when RLC SN from the PTM RB and the PTP RB are both assigned an RLC entity at the network entity and the UE PDCP entity provides PDCP status report to the network when PDCP SN from the PTM RB and the PTP RB are both assigned by a PDCP entity at the network entity.

19. The UE of claim 16, wherein RLC sequence number (SN) of data packets received from the PTM RB and the PTP RB are both assigned by an RLC TX-only entity at the network entity, and wherein the RLC SN for data packets received from the PTM RB and PTP RB are aligned.

20. The UE of claim 16, PDCP SN of data packets received from the PTM RB and the PTP RB are both assigned by a PDCP entity at the network entity, and wherein the UE RLC entity separates data packets from the PTM RB from the PTP RB before delivering to the UE PDCP entity.
